(19) United States
(12) Patent Application Publication
(10) Pub. No.: US 2015/0046669 A1
(43) Pub. Date: Feb. 12, 2015

(54) STORAGE SYSTEM AND METHOD FOR OPERATING SAME

(71) Applicant: SAMSUNG ELECTRONICS CO., LTD., SUWON-SI (KR)

(72) Inventor: SEONG-NAM KWON, BUCHEON-SI (KR)

(21) Appl. No.: 14/447,684

(22) Filed: Jul. 31, 2014

(30) Foreign Application Priority Data
Aug. 7, 2013 (KR) 10-2013-0093758

(51) Int. Cl. G06F 3/06; G06F 12/10; G06F 12/02

(52) U.S. Cl. CPC G06F 3/065; G06F 12/0246; G06F 3/0604; G06F 3/0679; G06F 12/1081; G06F 2003/0697
USPC 711/162

(57) ABSTRACT

A storage system includes a nonvolatile memory (NVM) and controller. The NVM includes a page buffer storing valid data and invalid data. The controller includes a processor providing copy control information, a hardware IP executing a copy operation that copies only the valid data, and a DMA that receives copy control information and controls operation of the hardware IP during execution of the copy operation response to the copy control information and referencing the valid data information stored by the DMA.

### CROSS-REFERENCE TO RELATED APPLICATION

This application claims priority under 35 U.S.C. 119 from Korean Patent Application No. 10-2013-0093758 filed on Aug. 7, 2013, the subject matter of which is hereby incorporated by reference.

### BACKGROUND

The inventive concept relates to storage systems and methods of operating storage systems.

The so-called direct memory access (DMA) is a conventionally well understood device that serves as an input/output (I/O) controller capable of moving data from one location in a data storage system to another without the intervention of control software running being executed by a Central Processing Unit (CPU), microprocessor, or control circuitry/software.

Data may be stored in many different locations using a variety of data storage circuits and/or devices (e.g., volatile memory devices, nonvolatile memory devices, registers, buffer memories, etc.). For many different reasons, it is often necessary to move (i.e., “copy”) data stored in one location to another location during operation of a data storage system. Data may be stored according to a defined data type, format and/or size. For example, in certain contemporary storage systems data is stored according to a defined data “page”. Thus, it is commonly necessary during the operation of conventional storage systems to copy a page of data from a source location (e.g., a first buffer memory) to a destination location (e.g., a second buffer memory).

The copying of data between locations in a storage system (i.e., the execution of a “copy operation”) will usually be controlled by an established “data management policy”. Conventionally, a copy operation may be executed by repeated execution of read/write operations under the control of firmware within the storage system CPU This approach consumes a great number of CPU computational cycles (i.e., CPU operating time) and related storage system resources. However, the control intervention by the CPU in order to effectively execute a copy operation is necessary since the data stored in a source location may not be homogeneously valid. That is, the possibility of invalid data amongst the to-be-copied data stored in the source location precludes the use of a simple, block copy operation to the destination location.

### SUMMARY

Embodiments of the inventive concept provide storage systems and methods of operating storage systems that improve the efficiency data copy operations.

One embodiment the inventive concept provides a storage system comprising a nonvolatile memory device and a controller configured to control operation of the nonvolatile memory device, the nonvolatile memory device including a source location that stores source data including valid data and invalid data, and a destination location, and the controller including a processor having firmware configured to provide copy control information, a hardware IP configured to execute a copy operation that copies only the valid data of the source data to the destination location, and a Direct Memory Access (DMA) configured to receive the copy control information from the processor and control operation of the hardware IP during execution of the copy operation, and including a DMA register storing valid data information, wherein the hardware IP executes the copy operation in response to the copy control information and with reference to the valid data information.

Another embodiment of the inventive concept provides a storage system comprising a nonvolatile memory device and a controller configured to control operation of the nonvolatile memory device, the nonvolatile memory device including a source location that stores source data including valid data and invalid data, and a destination location, the controller including multiple processors, each processor including firmware configured to provide copy control information, a hardware IP configured to execute a copy operation that copies only the valid data of the source data to the destination location, and a Direct Memory Access (DMA) configured to receive the copy control information from any one of the processors and control operation of the hardware IP during execution of the copy operation, wherein the DMA includes a DMA register storing valid data information and a lock register, wherein the hardware IP executes the copy operation in response to the copy control information, with reference to the valid data information, and in accordance with control of multiple copy operations requests made by the processors to the DMA.

Yet another embodiment of the inventive concept provides a storage system comprising a nonvolatile memory device and a controller configured to control operation of the nonvolatile memory device, the nonvolatile memory device including a source location that stores source data including valid data and invalid data, and a destination location, the controller including multiple processors, each processor including firmware configured to provide copy control information, a hardware IP configured to execute a copy operation that copies only the valid data of the source data to the destination location, and a single Direct Memory Access (DMA) configured to receive the copy control information from any one of the processors and control operation of the hardware IP during execution of the copy operation, wherein the DMA includes a DMA register storing valid data information, wherein the hardware IP executes the copy operation in response to the copy control information, with reference to the valid data information, and in accordance with control of multiple copy operations requests made by the processors to the DMA.

### BRIEF DESCRIPTION OF THE DRAWINGS

The above and other features and advantages of the inventive concept will become more apparent upon consideration of certain embodiments thereof with reference to the accompanying drawings in which:

FIG. 1 is a block diagram illustrating a storage system according to an embodiment of the inventive concept;

FIG. 2 is a block diagram further illustrating in one example the buffer 110 of FIG. 1;

FIG. 3 is a block diagram further illustrating the page buffer PB_{—}1 of FIG. 2;

FIG. 4 is a conceptual diagram further illustrating the DMA register 224 and processing unit (PU) 222 of FIG. 1;

FIGS. 5, 6A, 6B, 6C and 6D are respective conceptual diagrams that illustrate execution of a copy operation between page buffers according to an embodiment of the inventive concept;

FIGS. 7 and 8 are respective conceptual diagrams illustrating in one example a processing structure for copy control information according to an embodiment of the inventive concept;

FIGS. 9, 10 and 11 are respective conceptual diagrams illustrating certain methods of operating a storage system according to embodiments of the inventive concept;

FIGS. 12 and 13 are respective block diagrams illustrating exemplary data processing systems susceptible to the incorporation of a storage system consistent with an embodiment of the inventive concept.

### DETAILED DESCRIPTION

Advantages and features of the inventive concept and methods of accomplishing the same may be more readily understood by reference to the following detailed description of embodiments with the accompanying drawings. The inventive concept may be variously embodied and should not be construed as being limited to only the illustrated embodiments. Rather, these embodiments are provided so that this disclosure will be thorough and complete and will fully convey the concept of the inventive concept to those skilled in the art, and the present inventive concept will only be defined by the appended claims. Throughout the written description and drawings, like reference numbers and labels are used to denote like or similar elements.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

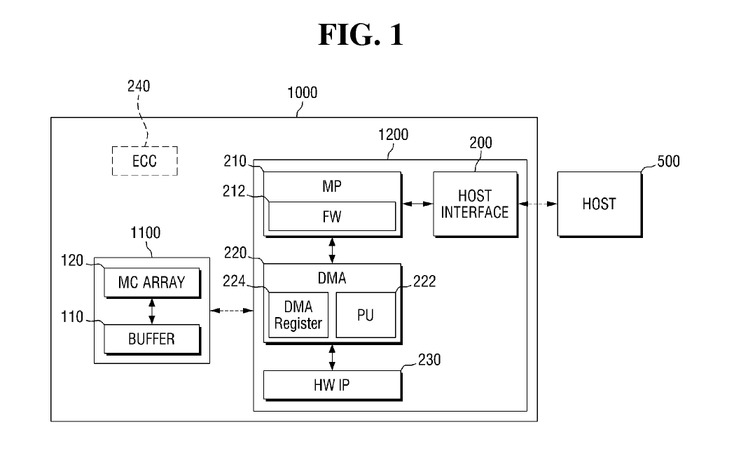

FIG. 1 is a block diagram illustrating a data storage system 1000 according to an embodiment of the present inventive concept. The storage system 1000 generally comprises a memory device 1100 and a controller 1200.

The memory device 1100 may include one or more nonvolatile memory device(s), such as conventionally understood NAND and NOR flash memory device(s). In FIG. 1, the memory device 1100 specifically includes a data buffer 110 associated with a memory cell (MC) array 120. Those skilled in the art will recognize that there are many different circuits and devices (e.g., a nonvolatile memory device) that may be used to implement the buffer 110. Similarly, there are many different ways to implement the memory cell array 120. Further, those skilled in the art will understand that one or more data buffers are often operationally associated with a nonvolatile memory cell array to facilitate the reading from and writing (or programming) of data to the nonvolatile memory cell array.

The memory cell array 120 may be implemented with single-level nonvolatile memory cells (SLC) configured to store a single bit of data per memory cell or with multi-level nonvolatile memory cells (MLC) configured to store 2 or more bits of data per memory cell. As will be conventionally understood, the memory cell array 120 may be operationally divided into a number of designated regions and sub-regions. For example, certain regions of the memory cell array 120 may designated as “data regions” configured to store general data while other regions may be designated as “spare regions”. Each designated region of the memory cell array 120 may include a number of sub-regions referred to as “memory blocks” or “blocks”, and each block may include a number of “pages”. Blocks and pages may be variously sized (and addressed) according to storage system operating requirements.

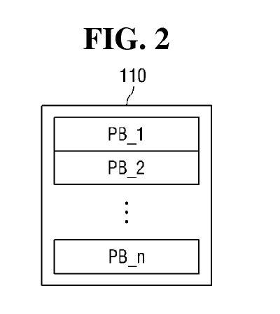

As shown in the illustrated example of FIG. 2, the buffer 110 may include a plurality of page buffers (e.g., PB_{—}1 to PB_n) adapted for use during program operations that program “write data” in the selected memory cells of the memory cell array 120, and/or read operations that retrieved “read data” stored in the memory cells of the memory cell array 120.

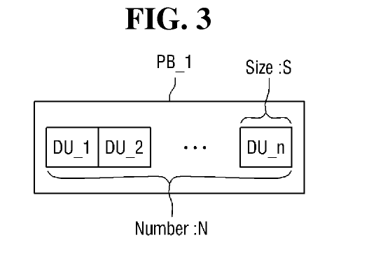

As further illustrated in FIG. 3, each page buffer (e.g., page buffer PB_{—}1) may be configured to include a number (N) of data units (e.g., DU_{—}1 to DU_n), each data unit being capable of storing data having a size (S). It is assumed in the description that follows that the storage system 1000 of FIG. 1 “manages” data according to the size and number of constituent data units DU_{—}1 to DU_n in order to receive write data from a host 500 and communicate read data to the host 500 in page-sized units. That is, the first page buffer PB_{—}1 shown in FIG. 3 is assumed to include data units DU_{—}1 to DU_n sufficient to receive, temporarily hold, and send a “page” of data, as the page unit is operationally defined within the storage system 1000. Accordingly, when it is assumed that the size of a defined “data transmission unit” for the host 500 is “S”, and that each page buffer (e.g., PB_{—}1) manages N data units each having a size equal to S, such that each page buffer handles a portion of write/read data having a size of N times S.

The configuration and operation of the controller 1200 shown in FIG. 1 will now be described in some additional detail with reference to FIGS. 1, 4, 5, 6A, 6B, 6C and 6D.

Referring back to FIG. 1, the controller 1200 comprises in relevant portion a host interface 200, a microprocessor (MP) 210, a DMA device 220, and a hardware IP 230. Of course, this is a simple (nearly minimalist) example of the functional and implementation complexity that characterize controllers in contemporary storage systems.

The host interface 200 is assumed to be operated in accordance with at least one data communication protocol capable of exchanging data between the host 500 and controller 1200. For example, the controller 1200 may be configured to communicate with the host 500 via at least one of various interface protocols, such as the universal serial bus (USB) protocol, multimedia card (MMC) protocol, peripheral component interconnection (PCI) protocol, PCI-express (PCI-E) protocol, advanced technology attachment (ATA) protocol, serial-ATA protocol, parallel-ATA protocol, small computer small interface (SCSI) protocol, enhanced small disk interface (ESDI) protocol, integrated drive electronics (IDE) protocol, etc.

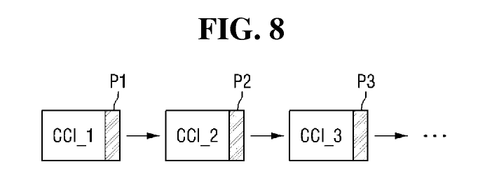

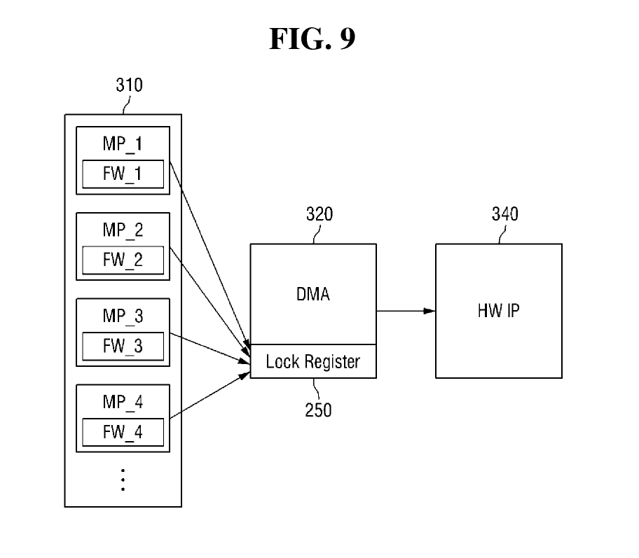

The microprocessor 210 include firmware 212, wherein the firmware 212 is assumed to provide “copy control information” (e.g., CCI_{—}1 to CCI_n shown in FIGS. 8 and 9) to the DMA 220 in order to execute copy operations using the DMA 220. Thus, the DMA 220 receives the copy control information from the firmware 212 and controls the operation of the hardware IP 230 to effect execution of the copy operation.

In the illustrated example of FIG. 1, the DMA 220 is shown as including a processing unit (PU) 222 and a DMA register 224.

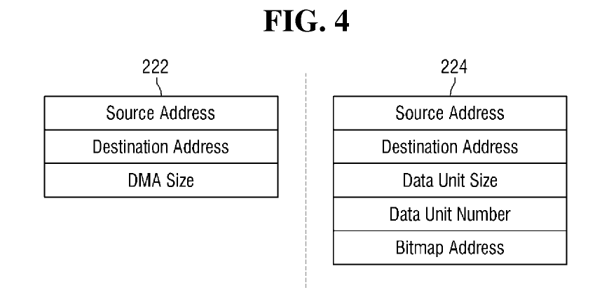

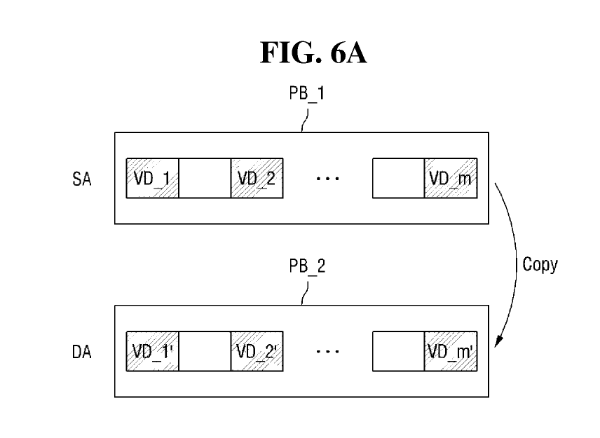

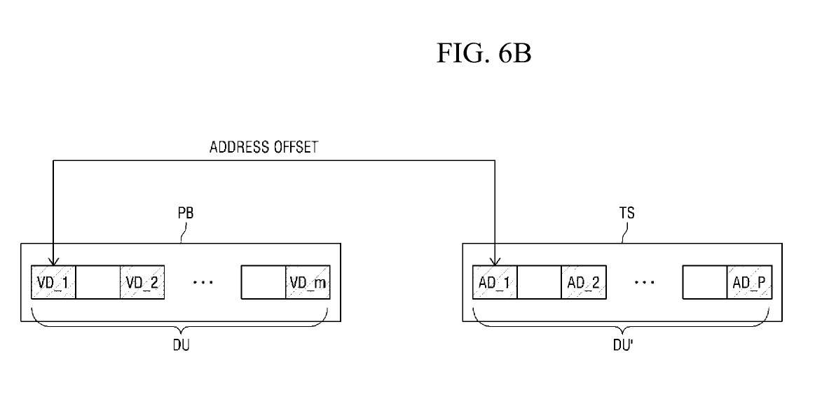

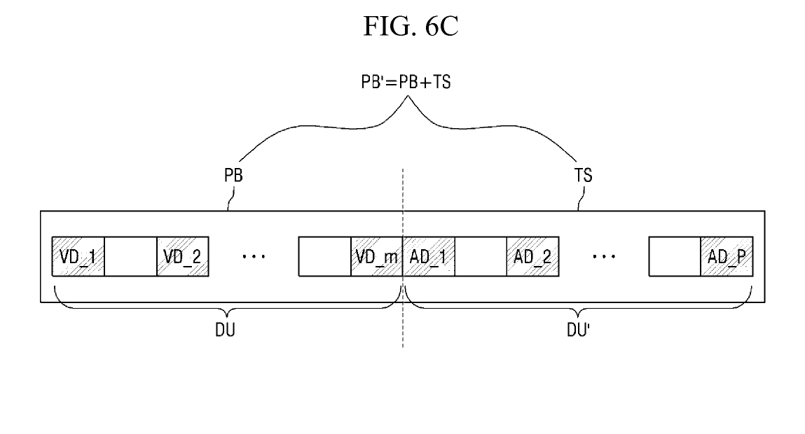

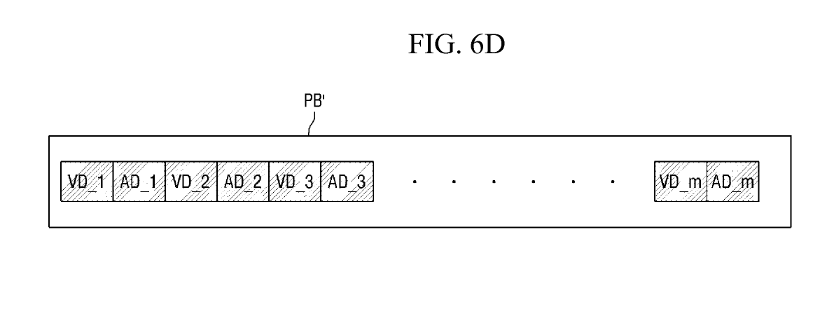

Referring to FIG. 4, the DMA register 224 may be used to store, for example, a page buffer address, data unit information, and a bitmap address. More particularly, the page buffer address may include a source address corresponding to a page buffer storing the “target data” that is the subject of the copy operation, and a destination address corresponding to a page buffer to which valid target data will be copied. The data unit information may include information indicating that size (S) and number (N) of the data units in each of the page buffers PB_{—}1 to PB_n. The data unit information may be preset before operation of the DMA 222 or dynamically determined during operation or power-up of the storage system 1000. The bitmap address may include bitmap information indicating “valid data units” (e.g., VD_{—}1 to VD_m of FIG. 6A, wherein ‘m’ is a positive integer not greater than the number ‘n’ of page buffers) presently stored by data units of a page buffer (e.g., DU_{—}1 to DU_n of PB_{—}1 shown in FIG. 3). Assuming that the size (S) and number (N) of the data units DU_{—}1 to DU_n is uniformly maintained by each of the page buffers PB_{—}1 to PB_n, the size and the number of data units DU_{—}1 to DU_n will therefore correspond to a predetermined bitmap address. Further, since the predetermined bitmap address corresponds to the information about the data units DU_{—}1 to DU_n, the DMA device 220 may control operation of the hardware IP 230 such that it copies only valid data units using the bitmap information.

Thus, the hardware IP 230 may be controlled by the DMA 220 during execution of a copy operation, and an exemplary approach to performing a copy operation using the hardware IP 230, without control intervention by the microprocessor 210, will be described hereafter.

Since the DMA register 224 illustrated in FIG. 4 according to an embodiment of the inventive concept further includes information regarding the size and number of data units DU_{—}1 to DU_n in a page buffer, as well as the bitmap address information, the hardware IP 230 may be used to copy only valid data held in corresponding data units of the page buffer without intervention by the firmware 212 of the microprocessor 210, regardless of any contrary control information applicable to the current operation of the processing unit 222.

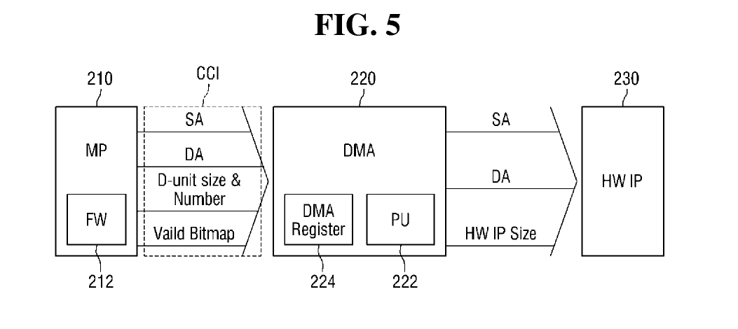

Referring collectively to FIGS. 5 and 6A, the DMA device 220 is assumed to store copy control information CCI received from the firmware 212 in the DMA register 224, and then extract valid data information from the DMA register 224. The effective data information may include, for example, information regarding the size and number of data units DU_{—}1 to DU_n, as well as the bitmap address information, but embodiments of the inventive concept are not limited to only these types of information. Whether one or more valid data units VD_{—}1 to VD_m exist in relation to target data held “stored” (i.e., temporarily held) in (e.g.,) the first page buffer PB_{—}1—assumed to be the source location for the copy operation—may be determined based on the valid data information extracted from the DMA register 224.

When at least one valid data unit of VD_{—}1 to VD_m is identified in the first page buffer PB_{—}1 (source location), the DMA device 220 may be used to control the hardware IP 230 so that only the valid data units are copied to (e.g.,) the second page buffer PB_{—}2—assumed to be the destination location of the copy operation. Further, since under these conditions the hardware IP 230 may be used without additional microprocessor control to execute the copy operation, the DMA 220 (as opposed to the microprocessor 210) may be used to request a hardware IP size (HW IP size) corresponding to the target data (D-unit Size & Number) stored in the source location from the hardware IP 230 and otherwise control operation of the hardware IP 230.

In this manner the hardware IP 230 may be controlled by the DMA 220 to copy only valid data units from the source location (e.g., first page buffer PB_{—}1) to the destination location (e.g., second page buffer PB_{—}2). That is, the hardware IP 230 may be used to effectively determine the valid data unit VD_{—}1 to VD_m among the target data stored by data units of the first page buffer PB_{—}1 as identified by a source address SA, and then copy only the valid data units VD_{—}1 to VD_m to the second page buffer PB_{—}2 as identified by a destination address DA.

An exemplary program code portion that may be used to facilitate execution of a copy operation directed to only valid data unit VD_{—}1 to VD_m in one embodiment of the inventive concept is shown below.

| | | |
|---|---|---|
| [ | 1. | for each data unit do |
| | 2. | if data unit is valid then |
| | 3. | copy valid data to destination addr. |
| | 4. | endif |
| | 5. | end for |

Referring to the above programming code portion, each data unit is applied (i.e., computationally considered) by a repetitive statement. In turn, valid data units VD_{—}1 to VD_m may be determined using an ‘if conditional sentence’ for each input data unit. After the determination process, the identified valid data units VD_{—}1 to VD_m may be copied to a destination location identified by the destination address DA. The foregoing programming code portion is just one example of many similar programming approaches that may be used to copy only valid data according to embodiments of the inventive concept.

Referring now to FIGS. 5, 6B, 6C and 6D, a data unit DU′ may include additional information AD_{—}1 to AD_p, where ‘p’ is a positive integer. The additional information AD_{—}1 to AD_p may include, for example, a cyclical redundancy check (CRC)/error correcting code (ECC) information for securing and/or verifying integrity of the data. In a case where the additional information AD_{—}1 to AD_p includes the CRC/ECC information, it is possible to identify whether data before and after the transmission is damaged through a check of the CRC/ECC. Further, the additional information AD_{—}1 to AD_p may include information indicating a data state or data characteristic of the data unit DU′.

Further, the hardware IP 230 may be used to copy the additional information AD_{—}1 to AD_p together with the valid data units VD_{—}1 to VD_m.

Referring to FIG. 6B, the additional information AD_{—}1 to AD_p, separated from the valid data units VD_{—}1 to VD_m by a predetermined address offset, may be copied together with the valid data units VD_{—}1 to VD_m.

Particularly, when the additional information AD_{—}1 to AD_p continuously exists at a specific location in memory, for example, at a location separated from the page buffer PB by a predetermined address offset, the additional information AD_{—}1 to AD_p may also be copied together when the valid data units VD_{—}1 to VD_m.

The additional information AD_{—}1 to AD_p may be stored in a temporary storage space (TS) separated from the page buffer PB by the predetermined address offset.

The temporary storage space TS may have a size different from that of the page buffer PB. For example, the size of the page buffer PB may be 512 bytes, while the size of the temporary storage space TS may be 8 bytes.

Referring to FIG. 6C, the additional information AD_{—}1 to AD_p stored in the temporary storage space TS continued right after the page buffer PB, that is, subsequent to the page buffer PB, may be copied together with the valid data units VD_{—}1 to VD_m. In the illustrated case, a final size of a page buffer PB′ may be the same as a sum of the size of the page buffer PB and the size of the temporary storage space TS. Here, the temporary storage space TS may have a size different from that of the page buffer PB.

Referring to FIG. 6D, the valid data units VD_{—}1 to VD_m and the additional information AD_{—}1 to AD_p may be mixed and copied together. In this illustrated case, a final size of the page buffer PB′ may also be the same as a sum of the size of the page buffer PB and the size of the temporary storage space TS.

Referring now to FIG. 1, the storage system 1000 may be configured to additionally include an error correction block 240, in addition to the memory device 1100 and the controller 1200. The error correction block 240 may be configured to detect and/or correct error(s) in read data retrieved from the memory device 1100 using a particular error correction code (ECC).

In certain embodiments of the inventive concept, the controller 1200 and memory device 1100 may be commonly integrated within a single semiconductor device. For example, the controller 1200 and the memory device 1100 may be integrated as one semiconductor device to configure a memory card, such as a PC card (personal computer memory card international association (PCMCIA)), a compact flash (CF) card, smart media cards (SM, SMC), a memory stick, multimedia cards (MMC, RS-MMC, and MMCmicro), SD cards (SD, miniSD, microSD, and SDHC), and a universal flash storage (UFS).

The controller 1200 and the memory device 1100 may be integrated as one semiconductor device to configure a semiconductor drive (solid state drive (SSD)). The semiconductor drive (SSD) includes a storage device configured to store data in a semiconductor memory. In a case where the storage system 1000 is used as the semiconductor drive (SSD), a speed of the operation of the host 500 connected to the storage system 1000 is remarkably improved.

For another example, the storage system 1000 is provided as one of various constituent elements of an electronic device, such as a computer, an ultra mobile PC (UMPC, a workstation, a net-book computer, personal digital assistants (PDA), a portable computer, a web tablet PC, a wireless phone, a mobile phone, a smart phone, an e-book reader, a portable multimedia player (PMP), a portable game device, a navigation device, a black box, a digital camera, a 3-dimensional television, a digital audio recorder, a digital audio player, a digital picture recorder, a digital picture player, a digital video recorder, a digital video player, a device capable of transceiving information in a wireless environment, one of various electronic devices configuring a home network, one of various electronic devices configuring a computer network, one of various electronic devices configuring a telematics network, an RFID device, or one of various constituent elements configuring a computing system.

For example, the memory device 1100 or the storage system 1000 may be mounted in various types of package. For example, the memory device 1100 or the storage system 1000 may be packaged and mounted by a method, such as package on package (PoP), ball grid arrays (BGAs), chip scale packages (CSPs), plastic leaded chip carrier (PLCC), plastic dual in line package (PDIP), die in waffle pack, die in wafer form, chip on board (COB), ceramic dual in line package (CERDIP), plastic metric quad flat pack (MQFP), thin quad flat pack (TQFP), small outline (SOIC), shrink small outline package (SSOP), thin small outline (TSOP), thin quad flat pack (TQFP), system in package (SIP), multi chip package (MCP), wafer-level fabricated package (WFP), and wafer-level processed stack package (WSP).

As described above, the storage system 1000 according to certain embodiments of the inventive concept is capable of copying only valid data from corresponding data units of a page buffer in response to firmware 212 associated with a controller microprocessor 210 providing only initial control information associated with the copy operation to the DMA 220. Thereafter, the copy operation may run in parallel with other (unrelated) computational functions performed by the firmware 212, while the DMA device 220 controls completion of the copy operation by within the storage system 1000. This approach improves the overall performance of the storage system, and particularly the microprocessor availability

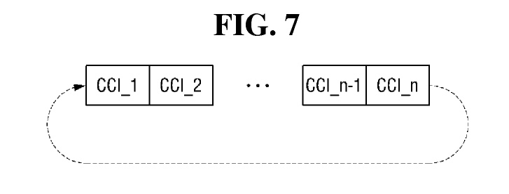

FIGS. 7 and 8 are conceptual diagrams illustrating a processing structure for copy control information according to embodiment(s) of the inventive concept. A description for the same constituent element as that of the previously described embodiment is omitted below, and a difference will be mainly described.

The copy operation executed by the storage system 1000 described with reference to FIGS. 1 to 6D has been described based on the single copy operation from the first page buffer PB_{—}1 to the second page buffer PB_{—}2. However, FIGS. 7 and 8 presuppose the execution of a number of copy operations.

Referring to FIGS. 1 and 7, copy control information CCI_{—}1 to CCI_n uniquely associated with a sequence of copy operations is continuously provided to the DMA 220. That is, the firmware 212 provides multiple and different sets of copy control information CCI_{—}1 to CCI_n to the DMA 220, and in response, the processing unit (PU) 222 within the DMA 220 may be used to count the number of sets of continuously provided copy control information CCI_{—}1 to CCI_n. When the counted value reaches the number of requested copy operations associated with the copy control information CCI_{—}1 to CCI_n, the processing unit 222 terminates the counting. After termination of the counting, the processing unit 222 may return a counting termination signal to the DMA 220 indicating completion of the copy operations associated with the copy control information CCI_{—}1 to CCI_n. Through the aforementioned process, the DMA device 220 may be used to control the hardware IP 230 to perform a number of (possibly successive) copy operations corresponding to respective copy control information CCI_{—}1 to CCI_n by fetching each set of copy control information CCI_{—}1 to CCI_n in a controlled execution sequence.

Referring to FIGS. 1 and 8, each set of copy control information CCI_{—}1 to CCI_n may be continuously provided to the DMA device 220 as part of a linked list. That is, multiple sets of copy control information CCI_{—}1 to CCI_n may respectively include pointers P1 to Pn-1 indicating next copy control information. Accordingly, the firmware 212 may be used to provide copy control information CCI_{—}1 to CCI_n to the DMA 220, and in response the DMA 220 may be used to fetch each set of copy control information CCI_{—}1 to CCI_n consistent with the pointer, and thereafter, the hardware IP 230 may be controlled to execute multiple copy operations corresponding to the respective copy control information CCI_{—}1 to CCI_n.

Various data structures, in addition to the aforementioned arrangement structure and linked list structure, may be adopted as data structure applied in order to process the plurality of copy operations corresponding to the plurality of pieces of copy control information CCI_{—}1 to CCI_n without an intermediate intervention of the firmware 212.

Further, in the structure of processing the plurality of copy operations according to another embodiment of the present inventive concept, the plurality of copy operations is performed by the hardware IP 230 without an intermediate intervention of the firmware 212, thereby maximizing parallelism and efficiency of the storage system.

FIG. 9 is a conceptual diagram illustrating a method for operating a storage system according to an embodiment of the inventive concept.

The foregoing examples have assumed a single processor core operating environment, wherein firmware 212 may be used to essentially request use of the hardware IP 230 by providing copy control information CCI to the DMA 220. Thus, the DMA 220 receives the copy control information CCI from the firmware 212 and may then be used to control the hardware IP 230 to execute copy operation(s) wherein only valid data stored in a source location are copied. This is done by extracting valid data information from the DMA register 224.

However, referring now to FIG. 9, a copy operation in a multi-core environment is assumed instead of the single core environment described in relation to FIG. 5.

In the multi-core environment, multiple microprocessors 310 may request use of the hardware IP 340 in parallel. A race-condition may be generated by the parallel requests of the use, so that in order to solve the race-condition, a lock register 250 may be added to a DMA device 320.

Particularly, the race condition may include a state in which the plurality of microprocessors 310 simultaneously attempts to access the hardware IP 340. In order to prevent the race-condition, the lock register 250 may be implemented, for example, in a form of touch-and-set or a read-and-modify. That is, when firmware FW_{—}1 to FW_n included in the plurality of microprocessors 310 read the value of the lock register 250 in order to identify whether the hardware IP 340 is first used in another place, the lock register 250 returns a fact indicating whether the lock register 250 is in a lock state or an unlock state. When the lock register 250 is in the unlock state, the DMA 320 changes the value of the lock register 250 to the lock state, thereby blocking an access of another microprocessor.

Accordingly, in a case where any one of the firmwares FW_{—}1 to FW_n within the plurality of microprocessors 310 accesses the lock register 250 and receives a return of the unlock state, the firmware receiving a return of the unlock state, may acquire an authority to use the hardware IP 340 without the race condition. When any one of the firmwares FW_{—}1 to FW_n within the plurality of microprocessors 310 receives the return of the lock state, the firmware not receiving a return of the unlock state cannot acquire an authority to use the hardware IP 340.

In methods of operating a storage system according to certain embodiments of the inventive concept, the lock register 250 is added to the DMA 320, so that it is possible to prevent the race condition by the plurality of microprocessors 310.

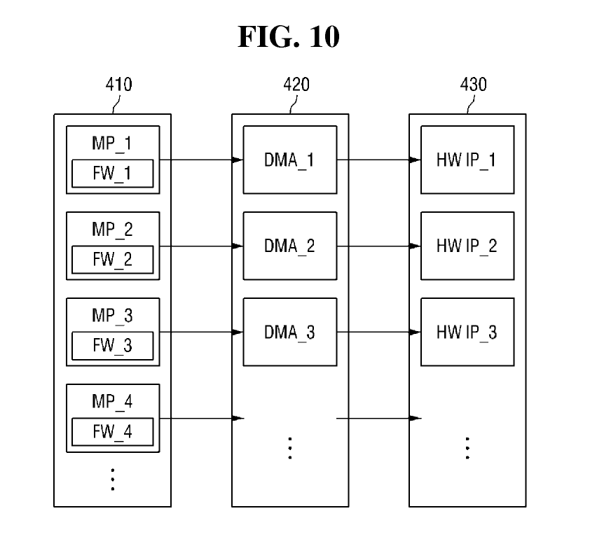

FIG. 10 is a conceptual diagram illustrating a method for operating a storage system according to another embodiment of the inventive concept.

Referring to FIG. 10, the storage system includes multiple DMA devices 420, so that it is possible to prevent the race condition even without using the lock register 250 described in relation to FIG. 9.

Particularly, multiple microprocessors 410 respectively correspond to multiple DMAs 420, so that it is possible to prevent the microprocessors 410 from simultaneously accessing the same DMA. Further, it is possible to prevent the race-condition without use of a lock register by preventing the microprocessors 410 from simultaneously accessing the same DMA.

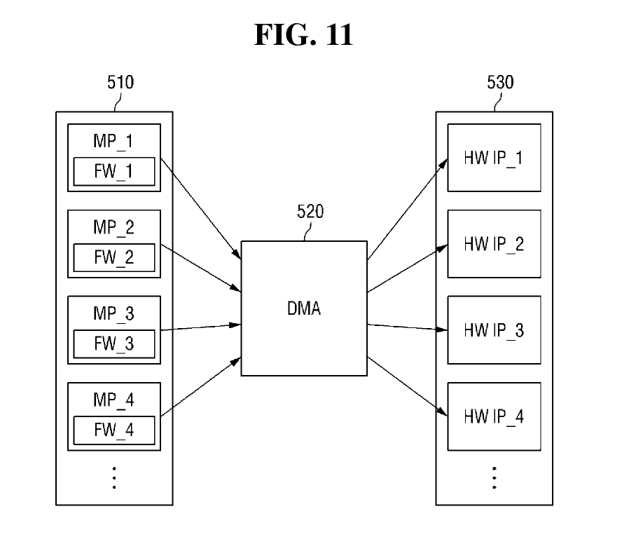

FIG. 11 is a conceptual diagram illustrating a method for operating a storage system according to still yet another embodiment of the inventive concept.

Referring to FIG. 11, multiple hardware IPs 530 access a single DMA device 520 in a manner that prevents the race condition even without use of a lock register or multiple DMAs.

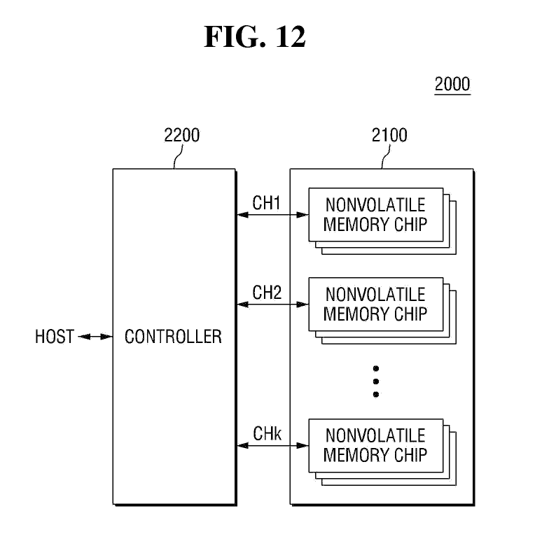

FIG. 12 is a block diagram illustrating one application example of the storage system of FIG. 1.

Referring to FIG. 12, a storage system 2000 includes a nonvolatile memory device 2100 and a controller 2200. The nonvolatile memory device 2100 includes a plurality of nonvolatile memory chips. The plurality of nonvolatile memory chips is divided into a plurality of groups. Each group of the plurality of nonvolatile memory chips is configured to communicate with the controller 2200 through one common channel. For example, it is illustrated that the plurality of nonvolatile memory chips communicates with the controller 2200 through first to k^{th} channels CH1 to CHk.

FIG. 12 illustrates an example wherein a plurality of nonvolatile memory chips is connected to one channel. However, it will be understood that the storage system 2000 may be modified so that one nonvolatile memory chip is connected to one channel.

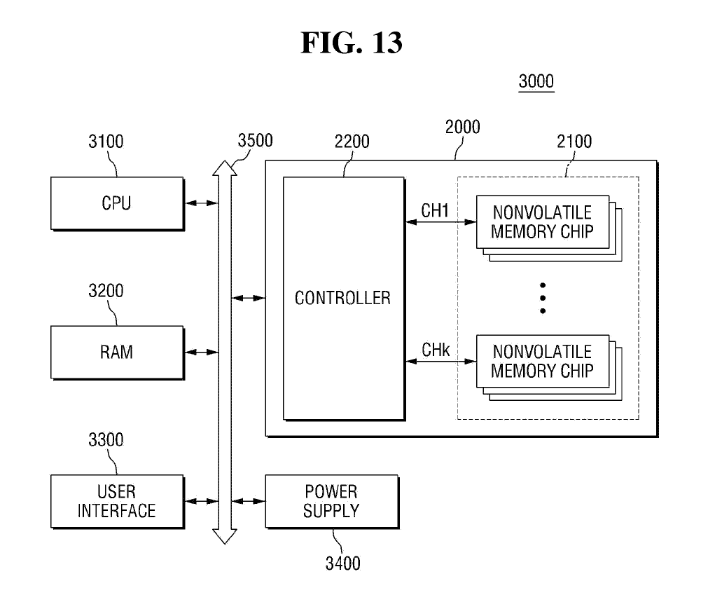

FIG. 13 is a block diagram illustrating a computing system including the storage system described with reference to FIG. 12.

Referring to FIG. 13, the computing system 3000 includes a central processing unit 3100, a random access memory (RAM) 3200, a user interface 3300, a power supply 3400, and the storage system 2000.

The storage system 2000 is electrically connected to the central processing unit 3100, the RAM 3200, the user interface 3300, and the power supply 3400 through a system bus 3500. Data provided through the user interface 3300 or processed by the central processing unit 3100 is stored in the storage system 2000.

In FIG. 13, it is illustrated that the nonvolatile memory device 2100 is connected to the system bus 3500 through the controller 2200. However, the nonvolatile memory device 2100 may be configured to be directly connected to the system bus 3500.

In FIG. 13, it is illustrated that the storage system 2000 described with reference to FIG. 12 is provided. However, the storage system 2000 may also be substituted with the storage system 1000 described with reference to FIG. 11.

For example, the computing system 3000 may be configured to include both the storage systems 1000 and 2000 described with reference to FIGS. 11 and 12.

The foregoing is illustrative of the inventive concept and is not to be construed as limiting thereof. Although a few embodiments of the inventive concept have been described, those skilled in the art will readily appreciate that many modifications are possible in the embodiments without materially departing from the scope of the following claims.

What is claimed is:

1. A storage system comprising a nonvolatile memory device and a controller configured to control operation of the nonvolatile memory device,
the nonvolatile memory device including a source location that stores source data including valid data and invalid data, and a destination location;
the controller including;
a processor having firmware configured to provide copy control information,
a hardware IP configured to execute a copy operation that copies only the valid data of the source data to the destination location, and
a Direct Memory Access (DMA) configured to receive the copy control information from the processor and control operation of the hardware IP during execution of the copy operation, and including a DMA register storing valid data information,
wherein the hardware IP executes the copy operation in response to the copy control information and with reference to the valid data information.

2. The storage system of claim 1, wherein the source location is a first page buffer of the nonvolatile memory device, and the destination location is a second page buffer of the nonvolatile memory device different from the first page buffer.

3. The storage system of claim 2, wherein the first page buffer comprises data units, each data unit storing a portion of the source data.

4. The storage system of claim 3, wherein the valid data information includes bitmap information identifying respective data units storing valid data.

5. The storage system of claim 4, wherein the valid data information further includes information regarding the size and number of the data units that corresponds with the bitmap information.

6. The storage system of claim 1, wherein the copy operation executed by the IP hardware includes multiple copy operations to be executed in sequence, and
the copy control information includes multiple sets of copy control information respectively associated with the multiple copy operations, and
the multiple sets of copy control information are continuously provided to the DMA to sequentially execute the multiple copy operations.

7. The storage system of claim 6, wherein the multiple sets of copy control information are arranged in a single data set as continuously provided to the DMA.

8. The storage system of claim 7, wherein the single data set as continuously provided to the DMA is a linked list.

9. The storage system of claim 7, wherein DMA comprises a processing unit configured to count a number of copy control information sets within the single data set.

10. The storage system of claim 1, wherein the nonvolatile memory device is a flash memory device, and the controller is commonly integrated with the flash memory device in a single semiconductor device.

11. A storage system comprising a nonvolatile memory device and a controller configured to control operation of the nonvolatile memory device,
the nonvolatile memory device including a source location that stores source data including valid data and invalid data, and a destination location;
the controller including multiple processors, each processor including firmware configured to provide copy control information,
a hardware IP configured to execute a copy operation that copies only the valid data of the source data to the destination location, and
a Direct Memory Access (DMA) configured to receive the copy control information from any one of the processors and control operation of the hardware IP during execution of the copy operation, wherein the DMA includes a DMA register storing valid data information and a lock register,
wherein the hardware IP executes the copy operation in response to the copy control information, with reference to the valid data information, and in accordance with control of multiple copy operations requests made by the processors to the DMA.

12. The storage system of claim 11, wherein the source location is a first page buffer of the nonvolatile memory device, and the destination location is a second page buffer of the nonvolatile memory device different from the first page buffer.

13. The storage system of claim 12, wherein the first page buffer comprises data units, each data unit storing a portion of the source data, and the valid data information includes bitmap information identifying respective data units storing valid data.

14. The storage system of claim 13, wherein the valid data information further includes information regarding the size and number of the data units that corresponds with the bitmap information.

15. The storage system of claim 11, wherein the lock register returns a fact indicating whether the hardware IP is in a lock or an unlock state for the request of the use of the firmware included in each of the multiple processors.

16. The storage system of claim 15, wherein in a case where the lock register returns the unlock state,
the DMA device changes the state of the lock register to the lock state.

17. A storage system comprising a nonvolatile memory device and a controller configured to control operation of the nonvolatile memory device,
the nonvolatile memory device including a source location that stores source data including valid data and invalid data, and a destination location;
the controller including multiple processors, each processor including firmware configured to provide copy control information,
multiple hardware IPs, each hardware IP configured to execute a copy operation that copies only the valid data of the source data to the destination location, and
a single Direct Memory Access (DMA) configured to receive the copy control information from any one of the processors and control operation of the hardware IP during execution of the copy operation, wherein the DMA includes a DMA register storing valid data information,
wherein the hardware IP executes the copy operation in response to the copy control information, with reference to the valid data information, and in accordance with control of multiple copy operations requests made by the processors to the DMA.

18. The storage system of claim 15, wherein the source location is a first page buffer of the nonvolatile memory device, the destination location is a second page buffer of the nonvolatile memory device different from the first page buffer, and first page buffer comprises data units, each data unit storing a portion of the source data.

19. The storage system of claim 16, wherein the valid data information includes bitmap information identifying respective data units storing valid data, and the valid data information further includes information regarding the size and number of the data units that corresponds with the bitmap information.

20. The storage system of claim 15, wherein the copy operation executed by the IP hardware includes multiple copy operations to be executed in sequence, and
the copy control information includes multiple sets of copy control information respectively associated with the multiple copy operations, and
the multiple sets of copy control information are continuously provided to the DMA to sequentially execute the multiple copy operations.

21. The storage system of claim 18, wherein the multiple sets of copy control information are arranged in a single data set as continuously provided to the DMA.

22. The storage system of claim 19, wherein the single data set as continuously provided to the DMA is a linked list.
